(19) United States
(12) Patent Application Publication
(10) Pub. No.: US 2016/0140671 A1
(43) Pub. Date: May 19, 2016

(54) System and Method for Dynamically Generating A Content Correlated Service Based Mobile Social Network

(71) Applicant: Jin Hong, Saratoga, CA (US)

(72) Inventor: Jin Hong, Saratoga, CA (US)

(21) Appl. No.: 14/543,855

(22) Filed: Nov. 17, 2014

(51) Int. Cl. G06Q 50/00; G06F 17/30

(52) U.S. Cl. CPC G06Q 50/01; G06F 17/30867; G06F 17/3053; G06F 17/30554

(57) ABSTRACT

A system and method of dynamically generating a content correlated service based mobile social network includes the steps of connecting users through automatic correlation and association of at least one of the common service characteristics and business classifications of the contents, based on sharing and matching of a set of favorite attributes of the contents and preference criteria of users, without the sharing of personal private and sensitive information. The system and method includes automatic self discovery of favorite businesses and services from the user's own preferences and those of the matching users in the user's internal and external social connections, and the online searching, ranking, notification and utilization of a list of recommended favorite businesses and services in the desired local proximity by the user. The system and method further includes the self generation, uploading, and update of the detailed records of the businesses and services that are readily accessible in such that the users and consumers can share their life experiences or personal preferences, and to establish mutual social connections based on their common interest to the local businesses and services.

### RELATED APPLICATION

This U.S. application is the official filing of the previously filed provisional U.S. Patent Application No. 61/908,658, filed on Nov. 25, 2013, entitled “System and Method for Dynamically Generating A Content Correlated Service Based Mobile Social Network”, and incorporated herein by reference.

### BACKGROUND OF THE INVENTION

1. Field of the Invention

The present invention generally relates to the technical field of data processing, and more particularly, to a system and method for dynamically generating a content correlated service based mobile social network.

2. Description of the Related Art

In the last decade, different types of social networks have gained momentum among different walks of people and societies. They are designed with different architectures, and targeted to serve different types of social communities. For example, some are generic to address the needs for communities of friends so that they can post and upload their personal information, events, thoughts, news and photos in their lives, such as Facebook.com and the related patents (Zuckerberg, et al. U.S. Pat. No. 8,412,821; Zuckerberg, et al, U.S. Pat. No. 8,352,859). Some are more specific so that they target an unique community of users, such as the one for professionals to post their resumes and working experiences onto the social networks, for example LinkedIn.com and related patents (Guo, et al, U.S. Pat. No. 8,831,969; Anand, et al, U.S. Pat. No. 8,694,635). Some others lay out specific sets of rules that control how people use such networks and interact with each other. For example, one may simply limits the length of text messages used for communications such as Twitter.com and the related patents (Mishne, et al, U.S. Pat. No. 8,612,529; Dorsey, et al, U.S. Pat. No. 8,401,009), or the time duration the uploaded photos can be viewed by friends before deletion by the system such as Instagram.com. There are also some other social networks focusing on either group chatting such as WhatsApp.com, or video conferencing such as Tango.me and the related patents (Sefton, U.S. Pat. No. 8,767,034; Dorso, U.S. Pat. No. 8,832,231).

The existing social networks mentioned above center around the user and reflect the user's social circles in real life. Normally, the online social network of a user is either based on the people the user knows already in real life, such as close friends, family members, classmates, colleagues, coworkers, business partners, professional encounters, through personal and family life or business connections, or based on the people who are newly introduced to the user through social events or networks of trusted friends. In most of the cases, once connected within the online social networks, the users are sharing some, sometimes even many, of their personal sensitive and private information, such as their past growing history, their professional life, their friends and social connections, their personal or professional activities, their historic moments and unique memories in real life events. These networks are built around the known group of people, the known social status and the known mutual relationships that surround the user. Each of these social networks serve a very different function in people's life, from group chatting, fast texting, free video calls, to personal sharing, and to professional job hunting. Most of them are focused on explicit people to people interaction functions within a closed and trusted networks of known social connections. This type of approach facilitates the human interactions and addresses one part of the daily life in acton. Among the connected communities of users, most of them share, to certain degree, some personal private and sensitive information as well.

In addition, there are online “matching” sites for dating and friendship making with several patents granted (Collins U.S. Pat. No. 5,963,951; Sutcliffe, et al. U.S. Pat. No. 6,073,105), such as Match.com which focuses on maximum matching for individual dating. This type of matching is based on the screening of personal private and sensitive information behind the walls of Internet. It does not provide any features for social community, mutual collaboration, multiple sharing, personal referral, or ranking reputation.

With the increasing reliance on Internet and social networks in every aspect of people's daily life, different and specialized social networks are required to fulfill diverse needs in life in order for people to leverage the advancement of Internet technologies to continuously improve their life quality and enhance their life styles. Furthermore, protection of sensitive information and individual privacy becomes increasingly much more important for most users within social networks. Hence there is another part of daily life that can be further assisted and enhanced by the social networks, which is related to the self recording, discovery, organization and recommendation of people's favorite daily needs, and of all the favorite local businesses and services that provide such needs to the users. Through the means of social networks, people can enjoy and organize their life better, and share their favorites and tastes with others more widely and conveniently. Therefore, a new social networking system and method that not only addresses people's favorite needs in daily life, but also requires no sharing of personal private and sensitive information is highly desired. This type of social networks focus on the interaction between people and their favorite businesses as well as the related favorite services. It is centered around the user and his or her individually tailored portfolio of favorite businesses and services which make the users' life unique and distinctive in its own right. Because of the user's uniqueness in his or her favorites and tastes in various services, the user can find out a group of closely matched users who may share the same or similar favorites and tastes in multiple categories. The more they share in common, the more likely they are alike in life or in person and can form circles of social communities of common interest in businesses and services, where they can further exchange and share their thoughts, opinions, experiences and findings in those businesses and services. In different business and service categories, the user may have a different set of closely matched users to form different circles of communities who share the same or similar favorites and tastes. Therefore, surrounding the user, different social circles of communities of the common interest with the matching users can form along different business and service categories, where the user and his or her matched connections can share and develop their common interest. While at the same time, the user does not need to know the matched users in person in real life and does not need to know their personal and private information. The user maintains his or her own independent list and personal records of the favorite businesses and services, and based on that, extends his or her social connections to all the matched users in various businesses and services through the common interest in such business and services. The user can further discover new favorite businesses and services in any locations based on his or her preferences and records, as well as on those from the highly ranked matching users of the viewing user in the business category of interest. In the case that the viewing user does not even have any prior experiences, preferences or records on any new business category, the viewing user can still discover a potential list of highly recommended businesses and services in that category though his or her own closely matched users in other business categories. These types of self discovery can be made through explicit external social connections of the matched users previously connected through the mutual acknowledgement based on common interest, as well as through the inexplicit internal social connections of the matched ranking users automatically found by the system and the method.

For example, people always have the tendency to search for good restaurants and dishes, wherever they are. They have also the strong desire to share the enjoyment of the delicious food they find and the excellent restaurants where they find these dishes, whether close to home or far out around tourist places. To share the moment, knowledge and enjoyment with people who may share the same tastes and passions about some specific restaurants, foods and dishes, has always been a common life experience among people. This originates from people's deep desire to explore, discover, express and contribute. From the common interest in restaurants and foods, the user may be able to find some new favorites such as favorite recreational places and services from the experiences of others in the user's internally and externally matched social connections.

Therefore, there is a great need to build such mobile social network dedicated to the exploration and sharing of favorite businesses and services. At the same time, this type of social network needs to be automatically built by a new system and method, that is unique and different from existing systems, based upon the sharing and matching of the common passion for favorite businesses and services, and based upon user's individual experiences and personal preferences, but not based upon the sharing of any personal private and sensitive information.

### SUMMARY OF THE INVENTION

The present invention is a system and method of dynamically generating a content correlated mobile social network, through the automatic linkage and association of at least one of the common business classifications, service characteristics, favorite attributes, and personal criteria about businesses and services, based on personal preferences and uploaded records of contents by users, to form various common interest social circles, where people share only some of their preferences without the need to share personal and private sensitive information of users.

The system and method includes a user interface means to obtain descriptive data and relationship data for users of the system. It further includes a database means for storing the descriptive uploaded data and relationship data of users of the system. It allows a user to choose one or more items from the available service characteristics, business classifications, favorite attributes and personal criteria through the user interface means, as the indicative reasons the relevant business and service is favored by the user. It also provides various algorithms to aggregate and calculate the data to create an internal connection map of any user's internal social network. The internal connections provide a network that matches two users with a common and shared interest in some favorite business and services. These type of automatic correlation of common interest in businesses and services enables the system to match one user with another with some indictions of relative ranking importance depending on the number of favorite businesses and services they share between them. The more they share in particular category in one area, the more likely they share in the same category in another area, and furthermore, the more likely they share in different business category as well. Furthermore, based on the privacy and connection preference setting of users, some of those internal connections between two users can be made open to each other and/or the common interest circles externally, if the request for external social connection is mutually accepted by both users through an invitation system and privacy protection mechanism.

According to one aspect of the present invention, it allows users to discover favorite businesses and services in any business category within any local community, all by themselves. The discoveries are based on users' own preferences and settings in their profile, their own uploaded data records where their preferences are contained in the server database, the preferences and uploaded data records from other users who are part of their internal connections based on the automatic correlations among users through the present invention. The favorite businesses and services discovered by the present invention for any particular user are ranked with priority by the present invention to indicate the relative strength of the matching to the user's personal preferences and the frequency of the occurrence of those matches. The present invention can automatically make a ranking recommendation list to the viewing user giving the specified location and business category of interest of the user.

According to another aspect of the present invention, it allows a user to discover favorite businesses and services in a new business category, that the user may not have any preference settings in his or her profile yet, and the user may not have uploaded favorite data records for this new business category in the server database either. Since the user may not have any known preferences, the system can automatically search for the preferences and uploaded dada records in the new business category through the internal and external connections of matching users with the viewing user. Those matching users are found by the system automatically through the use of the common interest in other known business categories where the viewing user has indicated his or her preferences, or uploaded his or her favorite data records. When a user has some common favorite businesses and services with other users in some business categories, the user can have a group of highly matched users who closely represent his or her taste and preference of favorites in these business categories. Therefore, through the discovery of the favorite businesses and services of those highly matched users in a new business category by the present invention, the viewing user can discover automatically a potential ranking list of the recommended favorite businesses and services in the new business category, even through the user may not have any prior preferences or favorites in this new business category in the past. The present invention enables a user to discover new favorites in a new business category based on his or her existing favorites in some existing business categories through the established internal and external social connections where the user has already indicated his or her shared preferences with other users.

According to yet another aspect of the present invention, it establishes internal linkage among users, based only on their shared favorites in some businesses and services. Those linkages are ranked relatively with strength based on the number of matches found between two users. The more favorite businesses and services in the same business category the two users are found to have in common, the more likely the two users would share the similar tastes and preferences in that business category. Additionally, the more business categories the two users are found to have common favorites, the more likely the two users would share a broad tastes and preferences on different topics. The higher ranking connection of a viewing user is the connection to the user who share the larger number of favorites with the viewing user across different business categories. Those users will be within the closer circles of the viewing user in the internal social network established by the present invention. If two users within such close circles would like to be explicitly linked socially, they can invite each other and become socially acquainted, once invitation for such connection is accepted by both. Additionally, both can still maintain their privacy and keep their personal sensitive information out of the external explicit social connection. They are connected only through their common share of some favorite businesses and services, and their common preferences in some specific areas, not through the share of privacy and personal sensitive information.

According to another aspect of the present invention, it establishes two domains of users, namely, the consumers, and the business and service providers, and maps them socially together, through the explicit indication of favorite businesses and services by consumers with certain business classifications, service characteristics, favorite attributes, and personal preference criteria. The dynamic social networks are formed among consumers directly through their common favorites of businesses and services, not through their known social linkage in real life.

According to yet another aspect of the present invention, it allows the business and service providers to dynamically and constantly update their business information, service categories, and specific service offering details including description, photos, pricing and etc. The business and service providers can make their business and service available online directly, so the consumers can actually automatically make online reservation, online ordering, and utilize online coupon directly, if they choose to do so.

According to another aspect of the present invention, it allows the consumers to not only indicate their favorites through various categorized options and upload their data records including description and photos to server database, but also place their favorite businesses, services, and the corresponding website links into their own accounts in an organized and categorized manner for future personal use and for recommendations to others. When a user logins into his or her account, the user can see all of his or her favorite businesses, services, and their website links organized into different folders and categories, in addition to all the data records the user has uploaded to the server database, plus all the ranking list of matched users in each business category.

### BRIEF DESCRIPTION OF THE DRAWINGS

In order for the manner in which the above described features of the present invention to be understood in detail, a more particular description of the invention, summarized briefly above, may be had by reference to various embodiments, some of which are illustrated in the appended drawings. It is to be noted, however, that the appended drawings illustrate only typical embodiments of the present invention and are therefore not to be considered limiting of its scopes and applications, for the present invention may admit to other equally effective embodiments.

FIG. 1 is a perspective view of the system digram of the content correlated mobile social network of the present invention.

FIG. 2 is a perspective view of the user matching method that allows one user to connect automatically to another user to form a social network circle through the discovery of their common interest by the present invention.

FIG. 3 is a perspective view of the service recommendation method that allows the mobile social network to recommend local services to a viewing user, based on the matching of at least one of the characteristics of the contents and services between the viewing user and other users based on the present invention.

FIG. 4 is a perspective view of the favorite service discovery method that allows a viewing user to discover some of the possible new favorite local services of other users through his or her shared interest with other users in their profiles and through their past history, based on the present invention.

FIG. 5a is a perspective view of the database structures and tables that define various groups of data and how they are connected. It relates to the initial information of users, businesses, their profile settings and preference settings, as well as their final internal or external connections for various social networking purposes.

FIG. 5b is a perspective view of the data base structures and tables that relate to the data contents generated by the users on either the business, or the business service, or the service menu items, or any combination of them, which are all uploaded by the users to the database servers over different times and from various locations. It also includes the generic list of definitions of the favorite attributes the system uses for users to choose from, and how the users are externally connected in the social network.

FIG. 6 is a perspective view of the detailed flowchart of the User Matching Method.

FIG. 7 is a perspective view of the detailed flowchart of the Social Recommendation Method.

FIG. 8 is a perspective view of the detailed flowchart of the Favorite Service Self Discovery Method.

### DETAILED DESCRIPTION

Embodiments of the present invention are described herein in the context of a system, method, and apparatus for dynamically generating a mobile social network linking users together automatically through their common interest in their favorite businesses and services based on content correlation among uploaded users' records inside the server database. Those of ordinary skill in the art will realize that the following detailed description of the present invention is illustrative only and is not in any way limiting to the scope of the present invention and the spirit of the underlining applications. Other embodiments of the present invention will readily suggest or present themselves to such skilled persons having the benefits of this disclosure of the present invention. Reference will now be made in detail to the implementations of the present invention as illustrated in the accompanying drawings. The same reference numbers will be used throughout the drawings and the following detailed descriptions to refer to the same or like parts in the present invention.

In the interest of clarity and simplicity, not all of the basic and routine features of the implementations in various embodiments described herein are shown in the drawings and described in the text below. It will be appreciated that numerous implementation specific decisions are made and that these specifics will vary from one implementation to another and from one developer to another, during any actual implementation of the present invention. It will be further appreciated that even though such implementation effort of various embodiments of the present invention might be significantly complex and overwhelmingly time-consuming, it would nevertheless be a relatively routine engineering undertaking and straightforward development execution program giving sufficient engineering resource allocations for those of ordinary skill in the art having the benefit of this detailed disclosure.

In accordance with the present invention, various major parts of the implementations of the embodiments, such as the components, process steps, and database structures may be implemented using various types of operating systems, computing and mobile platforms, computer languages, development tools and environments, databases and servers, transmission and storage environments, and other general purpose machines. In addition, those of ordinary skill in the art will recognize that devices and platforms of a less general purpose nature, such as hardware based devices, application specific integrated circuits (ASICs), or the like, may also be used without departing from the scope and spirit of the inventive concepts disclosed herein.

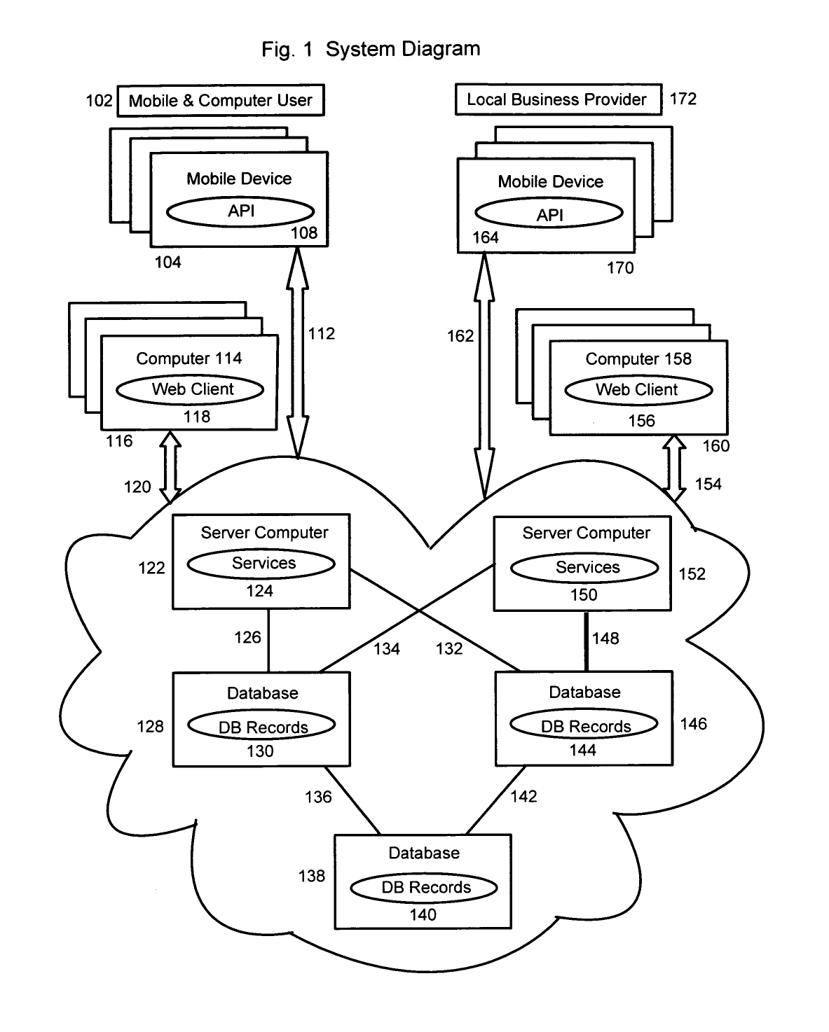

Referring now to the present invention in more detail, in FIG. 1, there is shown a generic architecture of a system and method for generating a mobile social network dedicated to content correlated connections among users and related businesses and services, in accordance with one embodiment of the present invention. As shown in further details in FIG. 1, there are a plurality of mobile and computer users 102, consisting of a plurality of mobile users 104 and a plurality of computer users 116. On a mobile device that a mobile user uses, there is a mobile application software based on the present invention that provides a mobile Application Interface 108 (API) for the user, to store the information locally on the mobile device. Additionally, on a computer 114 that a computer user uses, there is a computer application software that creates Web based client 118 for the computer user. Similarly, there are a plurality of local business providers 172, consisting of a plurality of mobile device users 170 and a plurality of computer users 160 in the business communities. On mobile devices, similar application interface (API) 164 is available for the business users. On a computer 158, Web based client for local business service providers 156 is available for the business user.

The mobile and computer users 102 and local business providers 172 are connected between them and among themselves through the wireless networks and/or Internet 120, 154, 112 and 162 to cloud computing systems in data centers. The communication channels 120, 154, 112 and 162 are bidirectional between the users and the cloud computers in the data center, and are connected to all users in the system, whether using mobile devices and computers, whether as individual users, consumers, or local service and business providers.

Inside the cloud based data center, there are multiple server based computers such as 122 and 152, that provide services 124 and 150, which access database storage 128, 138, 146, and the related database (DB) records 130, 140 and 144, through communications 132, 134, 126, 148, 136, and 142, respectively. Database 138 can be different from database 128 and 146 in the way that it can be accessed by other databases 128 and 146 directly through communications 136 and 142, respectively.

In further detail of the present invention, there is a software application package that can be downloaded and installed onto a user's mobile device and computer. Through the use of such application package, a user can take actions to generate “User Records” about his or her favorite “Business” and/or “Service Items”. One example of such “User Records” can be any combination of photos of food, dishes, restaurants, commentary or descriptive notes about the business and/or service items, voice recorded message and video clips. The user can also follow other users in the same favorite service social circles, check and download his or her own past favorite user records through Internet or wireless communication channels from the server computers in data center, upload his or her own new favorite records through communication channels to server computers, automatically obtain the promotion discounts or coupons or other special service information from the service providers, through the communication channels and from the server computers, request to be socially linked with other users sharing the same preferences of similar businesses and services such as the taste of the similar yummy food, accept request to be socially linked with other users to form a specific favorite service circle in a mobile social network. The server computers store all the user records and provide requested information and social networking application solutions to both the users and local business providers.

In further detail, still referring to the invention of FIG. 1, the mobile software application is designed with sufficient flexibility to allow a viewing user to take actions. It provides an easy way in the user interface for a user to indicate if the business and related service item, such as the specific food, dish, or restaurant has at least one of the service characteristics or favorite attributes the user prefers. The mobile application either automatically discovers and stores, or manually inputs and records, the time and the location of the viewing user's actions. It allows the user to upload his or her records of actions to the server computers in the data center and store these records in the database into organized formats that can be tracked, sorted, searched, and displayed at the request of a user, though the communication channel using mobile devices or computers. The records of the contents are stored based on a set of service characteristics, business classifications, favorite attributes, and personal criteria, provided by a user through his or her preference settings, uploaded records, or active actions of selection, complemented by the additional time and location information through the self discovery process of the mobile application by the use of the communication channel to connect back to the server computers to find such information, if such information is not already provided manually by the user using the mobile application interface.

The database structures are designed such that the records of users and service providers as shown in FIG. 1 can be easily uploaded, stored, accessed, sorted, searched, downloaded, and displayed by the system, by the users and the business owners. A user record consists of registered user name, identification, password, profile, preference in local services, sharing option, privacy setting, and other information in general. Furthermore, it also consists of user generated and uploaded contents about the business and services such as photos, accompanying complementary or descriptive note, associated voice records to explain the situation or to describe the contents, real time video clips, and user's indication of favorite preference, time and location of the user actions, and other characteristics and classifications about the business and services necessary to describe and categorize them in the database. Some of the additional characteristics and classifications, using yummy foods from related restaurants as example, are the culture heritage or regional linkage of the foods, and restaurants, the styles and the tastes of the food, the health specific aspects about some foods and the related restaurants.

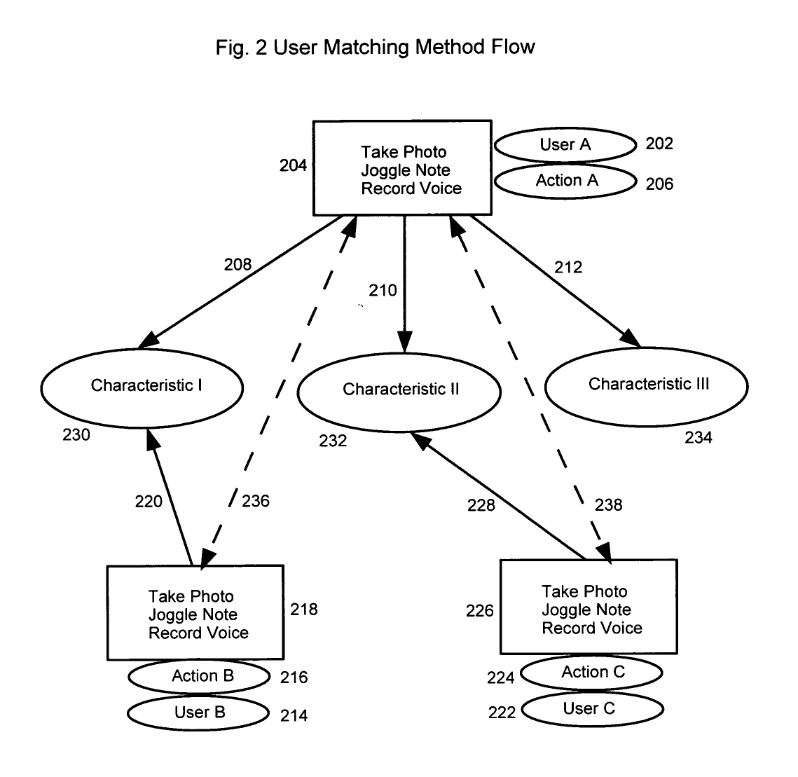

In more details related to the invention in FIG. 2, there is shown a system and method that provides a user matching method to link users together automatically to form content correlated social networks if they share common interest to some of the characteristics from the same local service. In the system, one User A 202 with a mobile device 204, can use this device to take photos of the contents of the service items from a service provider, joggle down some notes, record his or her voice comments, take a video clip, and etc. All of these information, plus a time stamp and location information of the action, form as part of the Action A records 206 related to the contents by User A. Similarly, other users have similar action records in the system, such as depicted in FIG. 2, where User B 214 with a mobile device 218 takes Action B to form some records of the action contents 216, while User C 222 with a mobile device 226 takes Action C to form some action records 224 in the same system. User A 202 has some records 206 stored in the server's database as shown in FIG. 1, while User B 214 and User C 222 have their records 216 and 224 stored in the same server database, respectively. One of the local services, which can be one of the dishes, one type of the foods, or one of the local restaurants providing such yummy dishes or foods for the yummy food service social networks as one of the examples, is shown to have several characteristics 230, 232, and 234 associated with User A 202 Action A records 206 in the server database. These characteristics are pre-determined by the design of the present invention, or selected by the viewing user initially on his or her own, for each specific service type the local business is providing. For the yummy food service, some of the example characteristics can be “Formal Dining”, “Vegetarian”, “Chinese”, “Japanese”, and etc.

In FIG. 2, User A 202 indicates his or her own preference of the local service based on Characteristic I, II, and III, as shown in 230, 232, and 234, respectively. User A's preferences of these Characteristics are indicated by the arrowed Preference Link 208, 210, and 212, respectively. In the system as shown in FIG. 2, User B 214 also indicates his or her preference of the same local service based on Characteristic I 230, as shown by the arrowed Preference Link 220. Similarly, User C 222 in the system indicates his or her preference of the same local service based on Characteristics II 232, as shown by the arrowed Preference Link 228. The system and method of the present invention automatically identifies the matching Preference Links between User A 202 and User B 214, based on their common preference of Characteristic I 230 of the same local service, as indicated by the arrowed Preference Link 208 and 220. The system automatically checks the privacy setting and sharing option in the registered User Profile for User A 202 and User B 214, to make sure that a Social Linkage can be established between User A and User B through the sharing of the same preference of the same Characteristic I 230 for the same local service. If the check on such settings provides permission to proceed, a formal mutual Social Linkage 236 is established in the system between User A 202 and User B 214. If the check in the system on the privacy settings and sharing options does not provide enough information to proceed based on some missing settings and options, the system initiates request to the viewing User A 202 or User B 214, or both for them to provide further permission to share their preference of Characteristic I 230 about the local service. If such request is granted, the system then establishes the Social Linkage 236. Similarly, a Social Linkage 238 between User A 202 and User C 222 is also established based on their common Preference Links 210 and 228, respectively, to Characteristic II 232, for the same local service.

In FIG. 2, the user matching Social Linkage is based on the match of at least one of the characteristics of the contents stored in the users' records in server database, between the viewing user and the other user, not based on sharing of any personal private and sensitive information. It is not based on the prior acquaintance of the other user through other normal daily life activities or by the introduction of other people in real social life.

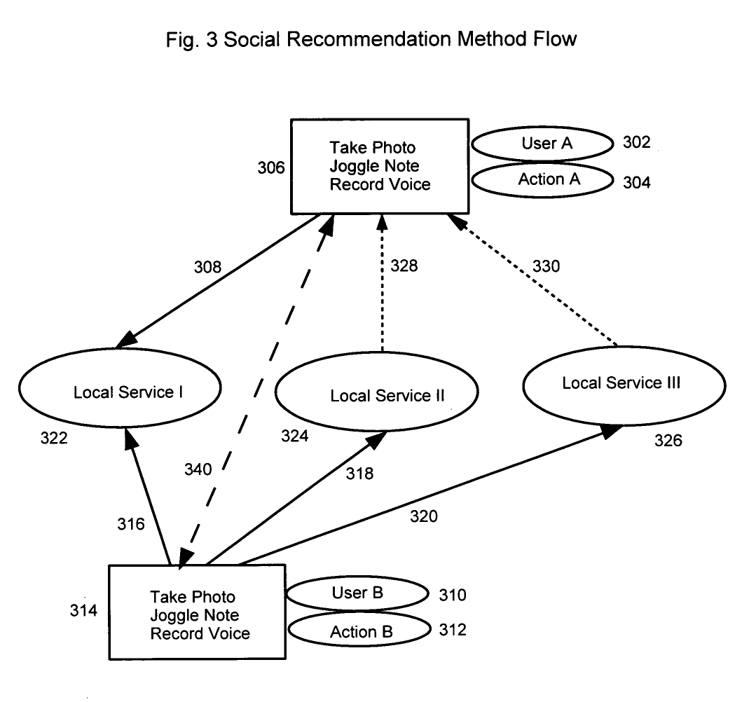

In more details related to the invention in FIG. 3, there is shown a system and method that provides a service recommendation method flow to recommend a preferred local service to the viewing user based on the matching to his or her own preference of at least one of the characteristics of the local service to be recommended by the system.

In FIG. 3, the viewing User A 302 with a mobile device 306, has some records of contents 304 generated in the past through Action A and stored in the server database of the system. The other User B 310 with a mobile device 314, also has some records of contents 312 generated through Action B in the past and stored in the server database in the system. User A 302 has established a Preference Link 308 of local service I 322, while User B 310 has established a Preference Link 316 to the same local service I 322. User A 302 and User B 310 have a common preference of at least one of the characteristics of the contents in their records about the same local service 322, and therefore there is an established matching Social Linkage 340 between User A 302 and User B 310. User B 310 also indicates that he or she has a Preference Link 318 to local service 324 and a Preference Link 320 to local service 326, with each Preference Link established in the system based on at least one of the common and preferred characteristics he or she indicates in the records of server database. If one of the preferred characteristics indicated by User B 310 for local service II 324 in the Preference Link 318 matches with one of the characteristics that User A 302 and User B 310 have indicated in their common Social Linkage 340, then the system can recommend local service II 324 to User A 302 using Recommendation Link 328, based on at least one of the common characteristics found through the Social Linkage 340, preferred by User B 310 in his or her Preference Link 318. Similarly, the system can recommend local service III 326 to User A 302 using Recommendation Link 330, based on at least one of the common characteristics found through the Social Linkage 340 and preferred by User B 310 in his or her Preference Link 320. How many of the local services that the system recommends to the viewing User A 302 each time is determined by the time, location of User A 302 automatically, based also on the profile setting and inquiry request of User A 302. The system provides a list with ranking orders based on the preference of the characteristics of the contents about each local service of interest that User A 302 indicates at the time of the viewing. The system searches for the common Social Linkage User A 302 has first, and then provides a Recommendation List based on the Recommendation Links from the Social Linkage User A 302 has.

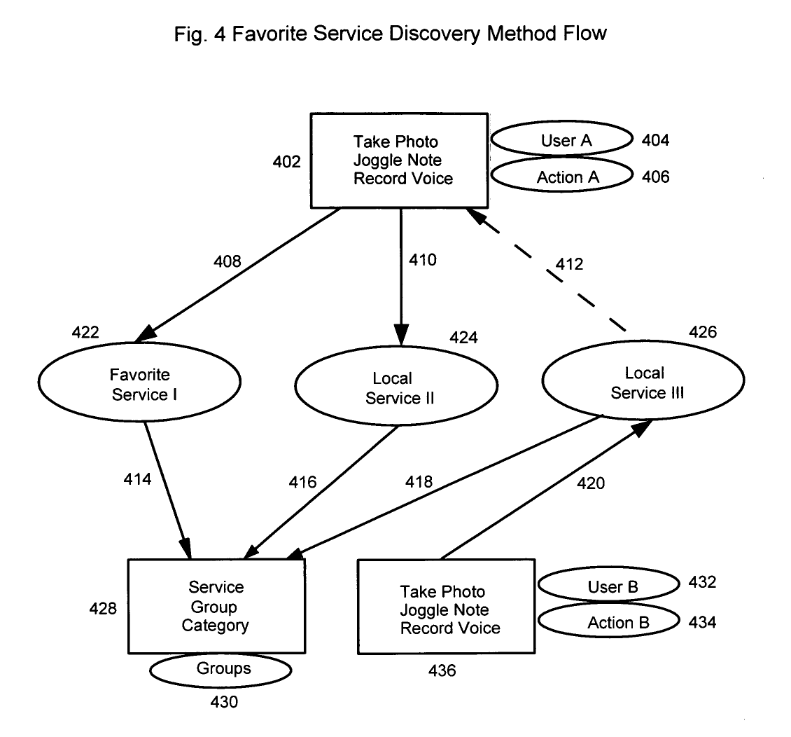

In more details related to the invention in FIG. 4, there is shown a system and method that provides a favorite service discovery method flow for the viewing user to discover a favorite service based on the social circle the user has and the profile he or she has set for himself or herself.

In FIG. 4, the viewing User A 404 with a mobile device 402, has some records of contents 406 generated in the past through Action A and stored in the server database of the system. User A 404 has some records for a favorite local service I 422 through the Preference Link 408 in the database, and also some records of a regular local service II 424 through Preference Link 410. Service I 422, Service II 424 and service III 426, all belong to a Service Group Category 428, through a link 414, 416, and 418 respectively. The Service Group Category 428 can be foods, restaurants, or other type of specific local services such as Barber Shop, Tea House, or Beauty Salon, and etc. This specific service group category 428 belongs to a much large group category 430. The other User B 432 with a mobile device 436, can have his or her own favorite local services, either in the same service group category 428, or in the larger group category 430. User B 432 has some records 434 in the database through Action B in the past. User A 404 has a favorite service I 422 either based on one of his or her favorite characteristics as indicated in his or her profile, or based on his or her own records 406 through Action A in the past. Based on that favorite link 408, the current invention can find out another local service III 426, either based on the characteristics of the local service III 426 as indicated by the service provider in the profile of the local service III 426, or based on the indication from another User B 432 through his or her favorite link 420 to local service III 426. The current invention can check and may find out that local service III 426 has one of the characteristics in the database which is favorited by User A 404 through favorite link 408. Therefore, the current invention can recommend to User A 404 that there is a local service III 426 that may be of his or her interest due to the presence of the favorite characteristic by User A 404 in local service III 426. Since the current invention is location aware, so even through the local service III 426 can be far away from local service I 422, when User A 404 is close to local service III 426 physically or searching in area close to local service III 426 on the map, the system will recommend local service III 426 to User A 404 based on a common favorite characteristic, through a recommendation link 412.

FIG. 4 outlines the system's recommendation to User A 404, based on his or her setting in personal profile about his or her favorite characteristics, or based on his or her past user records where User A 404 has indicated his or her own personal favorites in some of his or her personal records in the system's database. The system knows the favorite characteristic User A 404 has, no matter where User A is at the time of the viewing or at the time of request for searching. The recommended local service to User A 404 by the system can be determined by the same characteristic of the local services provided by the service providers, or derived by the system from the user records from other users who share the same characteristic as that of User A 404 for the same Service Group Category 428.

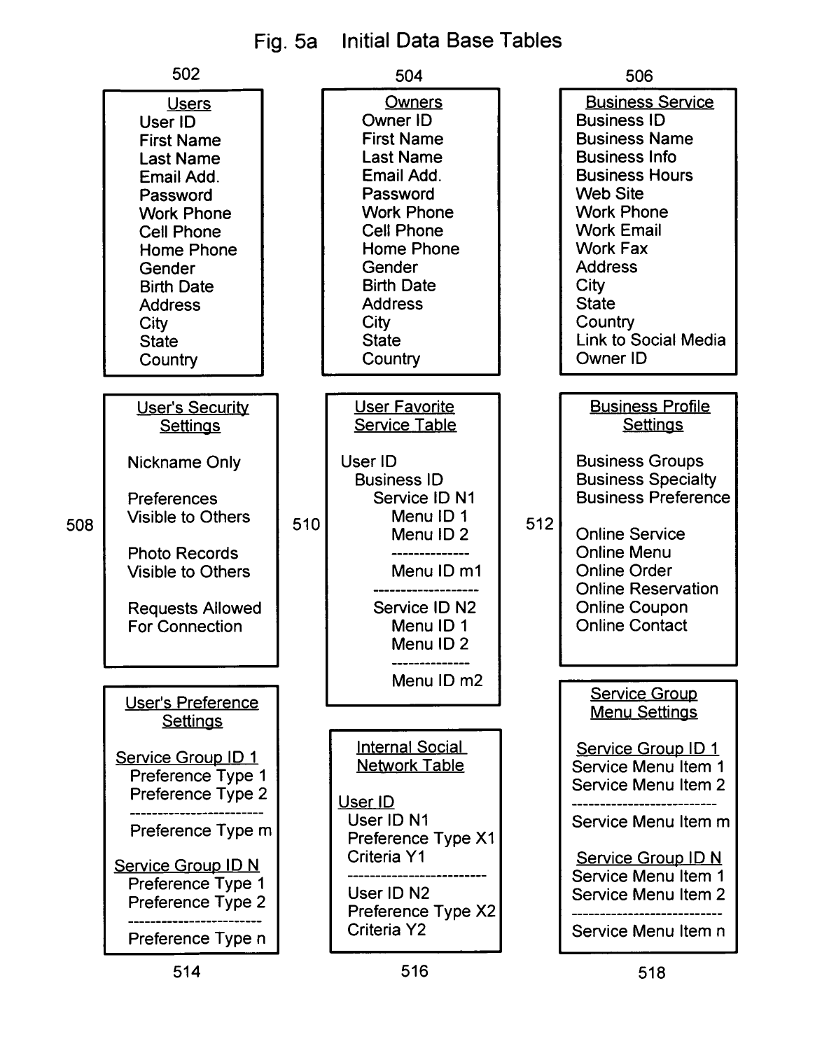

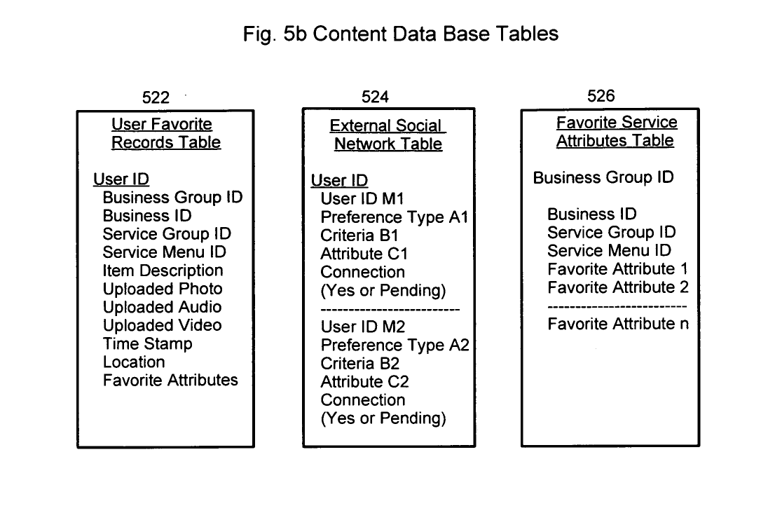

In more details related to the invention in FIG. 5a and FIG. 5b, there is shown a block diagram of an example of one of the implementations of a database in accordance with one embodiment of the present invention. The database stores descriptive data, digital images, and any other data items required by the other components of the apparatus. The database may be provided, for example, as object-oriented rational database package and accessed through a Structured Query Language (SQL) known to one of the ordinary skill in the art.

Several categories of information are shown in this implementation of the database. The categories include descriptive data, the preference data, and relationship data and other data items.

As used herein in FIG. 5a, descriptive data refers to information that describes a user, a business identity, or characteristics of a user or a business identity. For example, descriptive data might include users' information and business owners' information, such as User ID or Owner ID, First Name, Last Name, Email Address, Password, Work Phone, Cell Phone, Home Phone, Gender, Birth Date, Address, City, State, Country, and etc, as shown in Database “Users” Table 502, and Database “Owners” Table 504, respectively. Some of these information are necessary and some are optional. It also includes “Business Service” Table 506, such as business ID, Business Name, Business Information, Business Hours, Web Site, Work Phone, Work Email, Work Fax, Address, City, State, Country, Links to Social Media Sites, Owner ID, and etc. as shown in Database Table 506.

Among database tables in FIG. 5a, there are two other preference tables, which indicate the general preferences of users and business, and include “User's Security Settings” Table 508 and “Business Profile Settings” Table 512, respectively. “Users' Security Settings” Table 508 includes user's general preference on security in relation to the access of user's information, and may include such information as “Nickname Only”, which allows only his or her nickname to be used in the social networks, “Preferences Visible to Others”, which allows other users to view his or her personal preference of business service items, “Photo Records Visible to Others”, which allows others to view his or her photos uploaded onto and stored into the database server, “Requests Allowed for Connection”, which allows other users to make social connection request in order to get connected in the social networks based on common preference of certain sets of characteristics of business, business service, or business service items, in such that the user can have the option to ignore, reject or accept the connection request. “Business Profile Settings” Table 512 includes the necessary information to describe the business profile, specialty and preference, and may include such information as “Business Groups” which defines the business categories it belongs to, such as “Restaurant”, “Beauty Salon”, “Movie Theater”, “Club”, and etc., “Business Specialty” which defines the business's unique or distinct strength or specialty, such as “Chinese Food”, “Fast Food”, “Sea Food”, and etc., “Business Preference” which defines the business's own preference in many aspects, such as “Formal Dinning”, “Family Friendly”, “Corporate Events”, and etc. It may also include optional “Online Service” which indicates if the online service is available to the users, “Online Menu” which allows the users to view its menu or service items in great details (text or photo or both), “Online Order” which allows the users to order the service items directly from its own web site or the current mobile application, “Online Reservation” which allows the users to make reservation to the business for their specific service at a specific time, “Online Coupon” which allows the users to use the Online version of various business coupons when requesting business service, or making online order or reservation, “Online Contact” which allows the users to establish direct contact through online means, such as faxing, texting, email, phone calls, chatting, and etc., to the business or the business owner so that the business or the business owner can respond accordingly without losing the proper privacy.

As used herein, relational data refers to information that links the users with businesses, business service items, and other users in a comprehensive means and structures in order to support automatic formation of a dynamic underlining social network, and various unique new features associated with such invention. There are a total of four (4) relational tables in the database in FIG. 5a which includes “User's Preference Settings” Table 514, “User Favorite Service Table” 510, “Service Group Menu Settings” Table 518, and “Social Network Table” 516, respectively.

As shown in “User's Preference Settings” Table 514, a user can define some of his or her preferences in relation to the business type and business service item, which can include “Service Group ID” and “Preference Type ID”. The “Service Group” defines the group the relevant business belongs to, and some of them can be “Restaurant”, “Beauty Salon”, “Movie Theater”, “Club” and etc. Under the “Service Group” such as “Restaurant”, a user can specify his or her “Preference Type”, such as “Formal Dinning”, “Chinese Food”, “Veggie Food”, and etc. This table allows the application from the current invention to link users automatically with potential businesses based on users' preference, if no other information such as user's own records of favorite business is available in the database initially. This also allows the possible establishment of a shared internal linkage between two users through the current invention, when one or more preferences between two users are found to be in common, and possibly a share external linkage between the two users if both users permit such connection.

As shown in “Service Group Menu Settings” Table 518, one “Business” which belongs to one “Business Group”, can upload some or all of its service menu items under the “Business” category. Each of the “Service Menu Item” can be categorized into one specific “Service Group” user a specific “Business ID”. For example, the “Business Group” can be “Restaurant”, and the “Business” is named “ABC Chinese Kitchen”, where the “Service Group” can be “Soup”, “Seafood”, “Meat”, and etc. The “Service Menu Item” can be the information of various dishes under each “Service Group”. The information about each “Service Menu Item” can, for example, consist of name, description, photo, price, and some specialties related to this item. This table allows the “Businesses” or the “Business Owners” to use this application from the current invention to upload their detailed business service menu items on their own into the server database and can update them any time in any way they prefer to promote their business to consumers and end users. This table provides a detailed mapping of business service menu items so that the current application through this invention can help the users to find out their favorite service menu items based on users' own preference settings and their own uploaded records in the server database. The current application can also provide recommendations to users based on information stored in the database.

As used herein in FIG. 5a, relational database tables provide linkage between the users and businesses, or among users, as shown in the “User Favorite Service Table” 510 and “Internal Social Network Table” 516, respectively. In “User Favorite Service Table” 510, for each “User ID”, there are multiple “Business IDs” that are the favorite of the user. For each such “Business ID”, there are multiple “Service IDs” within that business. Under those “Service IDs”, there are multiple service “Menu IDs” which are the favorite of the user, either based on the matching between “User's Preference Settings” Table 514 and the “Service Group Menu Settings” Table 518, or based on the user's own records uploaded in the server database, or the combination of both. Since Table 510 relates each potential user with a specific set of businesses, it allows the application of the current invention to recommend to the user the potential new favorite services from a new business, and also allows the application to recommend potential favorite businesses to other users. In “Internal Social Network Table” 516, for each “User ID”, there are multiple other “User IDs” who are internally and automatically connected by this mobile application through the current invention to form an internal social network, which is visible to this mobile application of the current invention, but not necessarily visible to some external users. When both users have accepted each other's explicit request for connections, then the specific connection is not only visible to the current invention internally as determined by Table 516 in FIG. 5a, but also becomes visible to both users and forms part of the external social networks as determined by Table 524 in FIG. 5b. Each “User ID” is connected either internally or externally with another “User ID”, through the sharing of one or more common “Preference Types” and furthermore one or more shared “Criteria” used by the users or the businesses to define the unique characteristics of certain “Business”, or “Service Group”, or “Service Menu Item”. With this Table 516, this mobile application through the current invention can form two layers of mobile social networks, one is internal and visible only to the system in the server as shown by Table 516 in FIG. 5a, and one is external and visible to the users and business owners as shown by Table 524 in FIG. 5b. These social networks do not require the disclosure of personal information among connected users. It requires only the sharing of common characteristics or generic business attributes as defined by Table 526 in FIG. 5b, for certain business service menu items based on the knowledge of each other's preferences and uploaded records where the user can indicate his or her favorite business attributes about the specific relevant business, service, or menu items.

Each user's favorite records uploaded onto the database server is defined by the “User Favorite Records Table” as shown in table 522, where the Table contains “User ID”, “Business Group ID”, the favorite “Business ID”, the favorite “Service Group ID”, the favorite “Service Menu ID”. The user can favorite either the business, or the service group, or the service menu items, or some combination of them. There is no need that the user has to go to every level of the database structure. The user can indicate his or her favorite at any level in his or her uploaded record. Each record consists of the favorite “Item Description”, the favorite “Photo”, optionally, the favorite “Audio” or “Video”, the “Time Stamp” and “Location” by the user taking these records. Users also have option to choose from the default and generic “Favorite Service Attributes Table” 526, where the table contains the “Business Group ID”, the associated “Business ID”, the “Service Group ID”, the “Service Menu ID”. For the specific ID, there is a generic and default list of “Favorite Attributes” ranging from number 1 to number n for users to choose from. Additionally, when many users add their own “Favorite Attributes” into their records, and when these same records occurs frequently, the current invention will automatically add these “Favorite Attributes” to the default list for others to choose from too over time. When users have their own records, then the system can automatically find out whether some users share the same interest or “Favorite Attributes” to the same “Business” or “Service Group”, or “Service Menu Item”. If they do, the system can make an internal invisible connections between the users to form an internal social network based on Table 516 in FIG. 5a. When some of the users would like to make their own interest known to some other users and these other users would like to get connected with them likewise, then an external social network visible to these related users is formed by the current invention. The network is defined by the “External Social Network Table” 524. In this Table 524, one user is connected with the other user who shares some “Preference Type” or “Criteria” through both users' profile settings, or shares some common “Favorite Attributes” through their respective uploaded records about the same business. The external social connection can be made fully visible to both users if the connection requests have been accepted (in this case, “Connection=YES”) by both users, or still to be made visible by the system while waiting for the final confirmation by the other user regarding to one user's connection request (in this case, “Connection=Pending”).

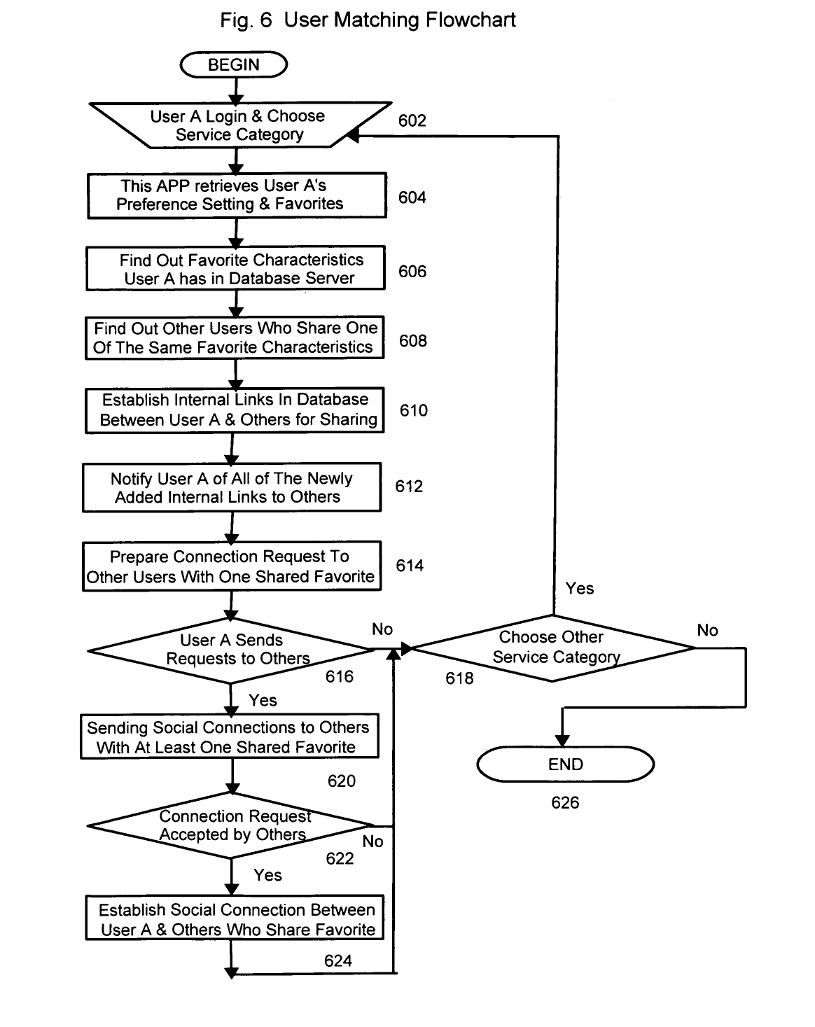

In more details related to the invention in FIG. 6, there is shown a flowchart that provides basic operation used in the “User Matching Method”. First of all, when the User A finishes login, or opens this existing mobile application, there should be a default “Business Group” already set automatically, by the current system, or by the chosen “User's Preference Setting” from Table 514 of User A previously, or by User A who chooses the “Business Group” from “Business Profile Settings” Table 512 after login so that User A's interested service category is selected, as shown in STEP 602. One of the examples for “Business Group” is “Restaurant”. With those chosen or default information, the system will go to the server database to retrieve User A's “Preference Settings” under the chosen “Business Group”. In addition, the system will retrieve all the user generated records in the past from the “User Favorite Records” Table 522 in FIG. 5b, about all of his or her favorite “Businesses” under the chosen “Business Group”, as shown STEP 604. After that, the system will find out if User A likes any specific and favorite characteristic called “Preference Type” under the “Business Group” from the “User's Preference Settings” Table 514, or from the past uploaded “User Favorite Service” Table 510, as shown in STEP 606, which derives such information from “User Favorite Records Table” 522 and “Favorite Service Attributes Table” 526 in FIG. 5b. Once the system has finished the checking on User A's own “Preference Type” in Table 514 and past “Favorite Service Table” 510, the system will further check to see if User A shares any common favorite characteristic with any other users under the same “Business Group” and “Business ID”, from the “Internal Social Network Table” 516 as shown in STEP 608. If a matching is found between User A and another User through Table 514 and 510, but such link is not found in Table 516, then the system will go ahead to establish an internal link in the system between User A and this other User, as shown STEP 610. In next STEP 612, the system will notify User A that a new internal link has been found and established that User A has common interest in at least one of the characteristics or one of the “Favorite Service Attributes” in one of the “Business” in an “Business Group”. These newly found internal links User A has with other users will be placed into “Internal Social Network Table” 516 as shown in FIG. 5a. After that, the system will check the other user's “Security Settings” Table 508 to see if the other user is willing to allow either the system or User A to make an explicit external request for social network connection, as shown in STEP 614. If allowed, the system will generate a connection request in STEP 616 and wait for User A to decide if he or she wants to send to the other user. If User A chooses “NO” in STEP 616 and decides not to send out the connection request, then the system will ask if User A wants to choose another service category as shown in STEP 618. If User A chooses “YES”, then the system will go back to STEP 602 to repeat the process to find out the matching user in another service category. If User A chooses “NO” in Step 618, then the system will end the “User Matching Method” flow as shown in Step 626. If User A chooses “YES” in STEP 616 and decides to send out the connection request to the other user, then the system will send out the connection request to the other user who has at least one “Preference Type ID” or “Favorite Service Attribute” for either the same “Business ID”, “Service ID” or “Menu ID” that matches with those of User A. If such connection request is not accepted by the other user at the time or over some period of time, in STEP 622, then the system will continue to go to STEP 618 for other service category. But if the other user accepts the connection request in real time or some time later in STEP 622, then the system will go ahead to establish the external link between User A and the other user in STEP 624. This process shall be completed for all other potential users who might have some matches in “Preference Type”, or “Criteria”, or “Favorite Service Attributes” with User A. The established connection will be placed in database “External Social Network Table” 524 as shown in FIG. 5b.

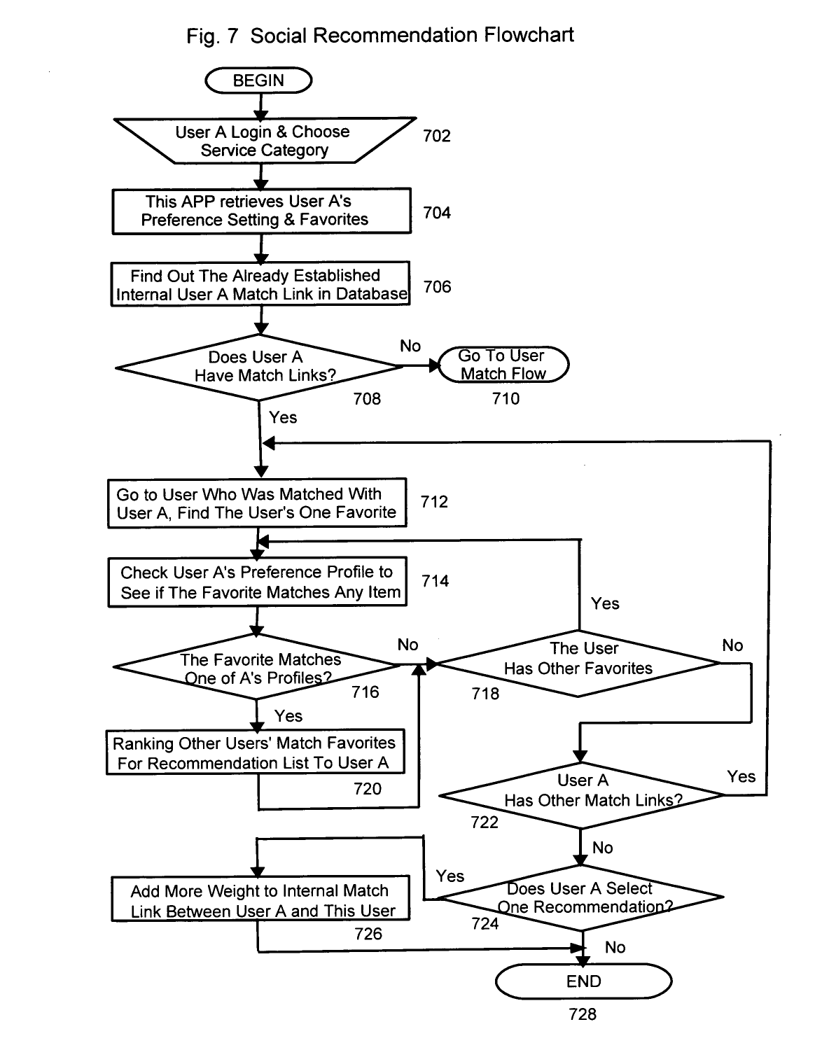

In more details related to the invention in FIG. 7, there is shown a flowchart that provides basic operation used in the “Social Recommendation Method”. The purpose of this method is to provide a user the ability to discover new favorite business or service from the same “Business Group” in the close proximity of the location of the user's interest, based on the user's “Internal Social Network Table” and “External Social Network Table”, through the favorites of other users who share some common interest in some of the characteristics or favorite business attributes. First of all, when the User A finishes login, or opens this existing mobile application, there should be a default “Business Group” already set automatically, by the current system, or by the chosen “User's Preference Setting” from Table 514 of User A previously, or by User A who chooses the “Business Group” from “Business Profile Settings” Table 512 after login so that User A's interested service category is selected, as shown in STEP 702. In addition, the system automatically detects the location of User A during the time of this mobile application and keeps tracking the change of the location. With those chosen or default information about services and locations, the system goes to the server database to retrieve User A's “Preference Settings” under the chosen “Business Group”. In addition, the system retrieves all the user favorite services in the past from the “User Favorite Services Table” 510 in FIG. 5a, to obtain all of his or her favorite “Businesses” under the chosen “Business Group”, as shown STEP 704 within a close proximity of User A's location by default or within a specific range to a point of interest as specified by User A. After that, the system goes to “Internal Social Network Table” 516 and “External Social Network Table” 524 to find out if User A has any established internal link to other users already in the database server. as shown in STEP 706. If User A does not have any internal link to other users, as shown in STEP 708, the system goes to STEP 710, where the user is then directed to STEP 606 in “User Match Flow” as shown in FIG. 6. If User A does have some internal social links in STEP 708, then the system starts the process of getting shared informations and making recommendations to the user based on his or her own interest as outlined in the profile settings and in the records uploaded by User A. Specifically, the system selects one user from the User A's matching internal link and obtains one favorite “Business ID”, or “Service ID′, or “Service Menu ID” in STEP 712 based on the “User Favorite Services Table” 510 from that user who has an internal link with User A. The system then checks the “User Preference Settings” Table 514 and the “Favorite Service Attributes Table” 526 to see if the selected “Business ID”, “Service ID”, or “Service Menu ID”, has any common characteristic that is among User A's favorites, as shown in STEP 714. After comparison in STEP 716, if the selected “ID” contains some characteristics that match with any of User A's favorite characteristics, the system can recommend this to User A. However, before making any recommendation, the system first compares this selected “ID” with other “IDs” on the recommendation list prepared for User A, as shown in STEP 720. The ranking is based on the “Preference Type” in Table 514 and the “Favorite Attribute” in Table 526, and the Location of the request, the number of matched preferred “IDs” between User A and the user, the number of the favorite “Business IDs”, “Service IDs”, or “Service Menu IDs” that are selected under the same “Preference Type” or “Favorite Attribute”, by the user and by User A, which can be used to indicate how heavily one “Business ID”, “Service ID”, or “Service Menu ID” is favorited by either User A or the user and to add corresponding weight to the ranking. Once the ranking recommendation list is updated in STEP 720, the system goes back to STEP 718 to continue the selection and ranking process, until it completes the search and comparison of all the favorite items by the one user that User A has an internal link with in STEP 718, and further more until it also completes the search and comparison of all the other users that User A has an internal link with in “Internal Social Network Table” 516 and “External Social Network Table” 524 in STEP 722. But in STEP 716, if the selected “ID” does not contain any characteristic that matches with any of User A's favorite characteristics, the system goes to STEP 718 to see the other user has any other favorite that can be selected and compared with User A's favorite characteristics. If the other user has more favorites that can be selected by the system for potential recommendation to User A, then the system goes back to STEP 714 for further comparison. If the other user has no more favorite, then the system goes to STEP 722 to see if User A has any other users in the “Internal Social Network Table” 516. If indeed, User A has other internal links to other users, the system then goes back to STEP 712 again and goes the rest of the recommendation process based on this new user's favorites in his or her own “User Favorite Services Table” 510. After the system completes the search and comparison in STEP 722, a complete service recommendation list with proper ranking is then generated. In STEP 724, the system presents the ranking recommendation list to User A. If User A selects one recommended item from the ranking list for further information or action, it means that this item is of high interest to User A, and the system can add more weight in the internal link between User A and the user who favorites this item originally in STEP 726. If later on, User A ends up with using this item and obtains the relevant service, and eventually indicates that he likes it and uploads some records, the system will add further weight to the item in the internal link between User A and the user with this item in STEP 726. But if in STEP 724, there is no item in the recommendation list, or User A does not select any of the recommended ranking list items, the system notifies User A that there is no business or service to recommend at this location and time. The “Social Recommendation Method” flow then exits in STEP 728.

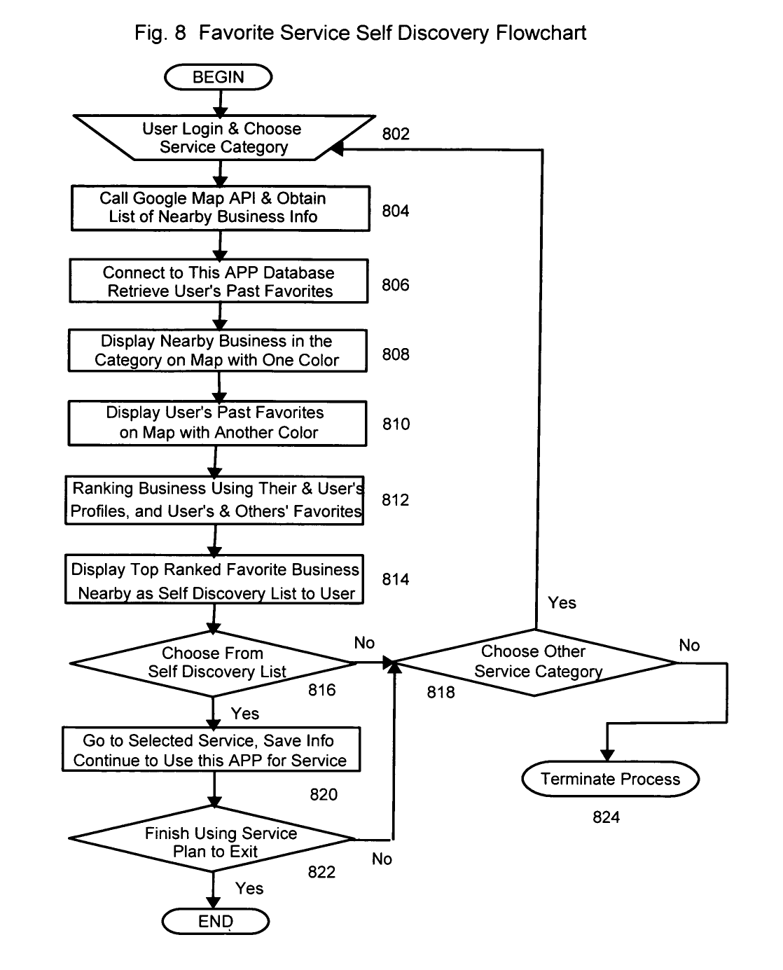

In more details related to the invention in FIG. 8, there is shown a flowchart that provides basic operation used in the “Favorite Service Self Discovery Method”. The purpose of this method is to provide a user with the ability to discover new favorites in different “Business Groups” at the proximity of the user, based on the user's past favorites in other “Business Groups” in the similar location. First of all, when the User A finishes login, or opens this existing mobile application, there should be a default “Business Group” already set in STEP 802, similar to those described in STEP 702 of FIG. 7. In addition, the system will automatically detect the location of User A during the time of this mobile application and keeps tracking the change of the location. With those information about services and locations, the system will go to STEP 804, in which the system calls out an API (Application Interface) from existing Internet business information providers, some of such examples are Google Map and Apple Map, to obtain a list of nearby businesses and the related information for each business. Furthermore, in next STEP 806, the system goes to the database server to obtain information of the user's past favorite businesses and services, from “User Favorite Service Table” 510 in FIG. 5a. Then in STEP 808, the system displays all the nearby business businesses, for example, on Google map or Apple Map, with a “rain drop” shape in one color. In STEP 810, the system further displays all the user's favorite businesses nearby on the same map too using a “rain drop” shape in another color in order to make a distinction between the normal nearby business and the favorite nearby business. STEP 812 involves multiple steps of its own in order to find out a list of new and potentially favorite businesses by the user, and to determine the relative ranking of the businesses on the list, based on all the known settings, preferences, and past favorite records in the database server by the user and the user's social connections, and the specialties and preferences of the businesses. In STEP 812, the system first uses “User Favorite Service Table” 510 to determine if any of the nearby businesses obtained from STEP 804 and 808 is already recorded in “User Favorite Service Table” 510. If It is already a part of Table 510 and displayed in STEP 806 and 810, then the system goes to the next nearby business obtained from STEP 804 and 808. If the business is not recorded in the “User Favorite Service Table” 510 and therefore not part of the information obtained from STEP 806 and 810, then the system goes to the “User Preference Settings” Table 514, and “Business Profile Settings” Table 512, to find out if the specific nearby business has any “Business Preference” or “Business Specialty” in the “Business Groups” from Table 512 that matches with the “Preference Type” from the “User Preference Settings” Table 514. If there is at least one or more matches between the user's preference and the business, then the system puts the specific nearby business into the list of self discovered favorite services and businesses. If there is no obvious matching between the user's preference in Table 514 and the business specialty and preference in table 512, the system goes to the “Favorite Service Attributes Table” 526, to find out if the specific nearby business matches with any of the user's “Favorite Service Attributes” in Table 526 under the current “Business Group” specified in STEP 802. If there is one or more matches, then the system puts this specific nearby business into the list of the self discovered favorite businesses or services. If there is no match with the user's preference in Table 526, the system goes further to the “User Favorite Records Table” 522, to find out if the specific nearby business is a favorite by any user in Table 522. If there is no match in Table 522, the system goes to the next nearby business obtained from STEP 804 and STEP 808 and continue the self discovery process. If there is at least one other user in Table 522 that favorites this specific nearby business, then the system puts the business into the list of self discovered favorite services or businesses first. The system then goes further to the “Internal Social Network Table” 516 and “External Social Network Table” 524 to find out if the other user has an internal connection in Table 516 or an external connection in Table 524 with the login User A. If the other user has no links with User A, the system goes ahead to make such connections from User A to the other user, using the steps similar to those from STEP 610 to STEP 624 in FIG. 6 as part of the “User Matching Method” flowchart. If the other user has an link already with User A, the system goes ahead to assign weight to this nearby business that matches with some favorite characteristics of User A in one way or another, through “User's Preference Settings” Table 514, the “Business Profile Settings” Table 512, the “User Favorite Service Table” 510, the “Favorite Service Attributes Table” 526, the “User Favorite Records Table” 522, and the combination of them. The more matches with the user's preferences and records in the database the system finds out through those tables, the more weight the systems assigns to the specific nearby business in the list of self discovered favorite services or businesses. The system repeats the process for all nearby businesses obtained from STEP 804 and STEP 808 until there is no more nearby business in the proximity of the selected “Business Group”.

After STEP 812, the system goes to STEP 814 to display to the user the newly found top ranked favorite services from the self discovery list obtained so far. In STEP 816, the user decides if he or she wants to select one of the recommended favorite services. If the user chooses one of the recommended favorite services, the system first saves the information of the business into the category of user's favorite “Business Group” under the viewing user's corresponding favorite “Personal Groups” in his or her account. Some of the embodiments of “Personal Groups” under the user's account are “My favorites”, “Spouse's Favorites”, “Kids' Favorites”, “Relatives' Favorites”, “Friends' Favorites”, and etc. Some other embodiments of “Personal Groups” are “Work”, “Finance”, “Education”, “Recreation”, “Opportunity”, “Hobby”, “Social”, and etc. In addition, some of the embodiments of “Business Groups” are ranging from restaurants, event catering companies, coffee shops and tea houses, movie theaters and entertainment places, night clubs and sports bars, to public parks and beaches, recreational and vocational places, and etc. Some other embodiments of “Business Groups” can cover businesses around family need or personal interest, such as tutoring services for various activities of kids, banking and investment services for family and personal finance, tax and legal services, job and business opportunities, personal hobby and etc. After the favorite information is categorized and stored in the server database, the user continues to explore the selected service, either for further information, or for utilization of the online services related to the business, such as online ordering, or online reservation, or online coupon, or any relevant online service in STEP 820. After finishing the use of the relevant service online in STEP 822, the user can choose to end the session or continue to STEP 818. If the user does not choose any recommended favorite services in STEP 816, the system also goes to STEP 818. In STEP 818, if the user chooses to continue and selects another service category in different “Business Groups”, the system goes back to STEP 802 and repeats the same process for the new category in order to find out a new list of self discovery in the new category. If the user chooses not to select another service category in STEP 818, the system exits from the self discovery process in STEP 824.

The advantages of the present invention include, without limitation, a mobile social network dedicated to people connected through common shared interest to certain businesses and associated business services, and generated through automatic correlation of the shared characteristics and classifications of the businesses and services. In such mobile social network, the information generated and uploaded by the users, are organized as records of the contents of businesses and services, and shared among users' self generated social circles that are built around specific types of businesses and services based on users' own personal preferences, while users' personal private and sensitive information are not shared among the users even within the same social circles.

Furthermore, the advantages of the present invention include, without limitation, that the mobile social network is automatically centered and built around the sharing interest of contents about favorite businesses and associated services by people in the same social circles, not around the social circles of people who either already know each other in real life or get introduced by trusted friends prior to the connection in such new mobile social network.

Still furthermore, the advantages of the present invention include, without limitation, that the mobile social network is automatically built with two types of intervening sub-networks with different focus. The first sub-network is centered around the individual users who build various social circles with people who share the similar interest about some businesses and services. This sub-network is based on users' circles, or the circles of the end customers of business service providers. This sub-network is mainly built by the users and assisted by the system and methods introduced in the present invention. The second sub-network is centered around individual service providers, who create and upload their business and detailed service item information onto database server as part of their business and service records, which can be accessed and shared by many end consumers so that these consumers can share their favorite businesses and services based on the uploaded records from both businesses and end consumers, using the current system and method in the present invention. The second sub-network is based on business circles, or the circles of service providers. It is also automatically generated by the present invention. Both the users' sub-network and service providers' sub-network are seamlessly connected in the mobile social network through the present invention automatically.

In broad embodiment, the present invention is a system and method for dynamically generating a content correlated mobile social network, that is based on the shared association and common correlation of at least one of the characteristics and classifications about the businesses and services.

In specific implementation example case, the contents can be made of the records users and the present system generate together which contain at least some of the preferred characteristics about the contents such as photos, notes, voice recording, user preferences, time and location of such records for the businesses and services.

While the foregoing written description of the invention enables one of the ordinary skill to make and use what is considered presently to be the best mode thereof, those of ordinary skill will understand and appreciate the existence of variations, combinations, and equivalents of the specific embodiment, system, method, and examples herein. The invention should therefore not be limited by the above described embodiments, systems, methods, and examples, but by all embodiments and methods within the scope and spirit of the invention as claimed.

What is claimed is:

1. In a mobile computing system including a server and a database of registered users connected through Internet or wireless communication means, a method dynamically generating a mobile social network, based on characteristics and classifications of businesses and related services, users' personal preferences, priorities and their uploaded records in the server database with regard to their specific interest and feedback about the relevant businesses and services, and automatically managing, correlating, selecting, ranking and displaying the necessary contents of interest to users in time sensitive and location aware manners, the method comprising the steps of:
Displaying to the registered viewing user the personal favorite contents of businesses and services at the time and location of viewing, obtained from the computer system database, based on the user's history of uploaded records and past preferences of those favorite contents, and other available nearby businesses and services within the desired proximity of the user;
Retrieving from the computer system database, the favorite contents of nearby businesses and services of other users who are linked together with the viewing user in this mobile social network through the sharing of certain common interest to some other businesses and services, and ranking the nearby businesses and services in relation to the preferences and location of the viewing user, based on the matching and weighting to a collection of service characteristics, business classifications, personal criteria, favorite attributes, among the viewing user, the users linked with the viewing user, and all the nearby businesses and services within the desired proximity of the viewing user, displaying accordingly to the viewing user a recommended ranking list of the favorite contents of businesses and services for the user to choose from pending on the privacy and preference settings of the viewing user;
Allowing the viewing user to take actions to generate more favorite contents of businesses and services of personal interest, which is made of any form of photos, notes, messages, voice records, video clips, and a combination of some of them, through the use of available capabilities from smart phones or other computing devices, and to upload and download his or her own favorite records to or from the server database respectively;
Providing means for the viewing user to indicate or to add certain favorite characteristics, classifications and attributes to the user favorite records each time when they are generated, with time stamps, location indicators, personal preferences, security settings, sharing options, and additional notes and criteria that are not already built in the computer system, or not in the profile settings of the user or the businesses and services. Such an indication to the businesses and services is achieved either through the active selection of the user, or the automatic correlation by the computer system by means of matching the favorite records with the location of the user, and the registered profiles of the user, the business, and the related services;
Providing means for the viewing user to upload such user generated favorite records, their characteristics and classifications onto the computer server and database through the Internet or wireless communication means;
Storing the user's newly generated favorite records in the computer server and database in such that the records become trackable, sortable, retrievable, viewable, and shareable through the recorded characteristics, classifications, attributes and criteria, not only by the users, but also by the contents they contain;
Correlating the viewing user's records with those similar records of other users in the computer server database, calculating and determining a matching list of possible linkages with priority ranking between the viewing user and some other users, based on their preference settings, security profile settings, contents of favorite records uploaded onto the server database, the favorite characteristics, classifications and attributes indicated in their records, the active status of the relevant users, and displaying such matching list of ranking users to the viewing user, with consideration to additional display and sharing options and restrictions set by the viewing user and the matching users;
Providing means for the viewing user to initiate an invitation to the selected matching and ranking users to join a specific content correlated social circle, either existing or newly created by the viewing user, where the favorite records, viewpoints and further information about the contents of the businesses and services are shared, exchanged, discussed and further expanded;
Providing means for the receiving user of the invitation to join a content correlated circle to take proper actions, to either accept, forward, ignore, reject the invitation, or report to the system as an issue to be addressed, and to allow the initiating and accepting users to be connected in the specific social circles once accepted, so that each user can further explore other user's favorite contents of businesses and services through the shared and open preference linkages;
Providing means for the viewing user to review his or her own active statistical status in the specific circle about the relevant contents of the businesses and services, as well as the status of a ranking list of other users visible to the viewing user in the circle, in such that the viewing user can further initiate request to join other circles of interest through the other ranking users, which needs to be accepted by the other user or the owner of the circle before joining, unless the joining of such circles is made open to the public by the owning user;
Providing means for the viewing user to automatically discover other matching users with shared interest in some characteristics, classifications, attributes, criteria to some businesses and services, so that the the viewing user can build up his or her own social network circles, either internally in the computer system, or externally through the mutual connections with the matching users, to form a content correlated favorite focused communities of his or her interest, without the compromise of personal private and sensitive information;
Providing means for the viewing user to automatically discover a ranking list of recommendation of favorite businesses and services under the same business category of user's interest, within the desired proximity of the viewing user, which matches with the user's preference settings and the historical indications of user's preference in the uploaded favorite records;
Providing means for the viewing user to automatically discover a ranking list of recommendation of favorite businesses and services under one business category of user's selection, within the desired proximity of the viewing user, based on the preference settings and the historical indiction of the preferences in the uploaded favorite records under another different business category by the user, and based also on the preferences and favorite records under the same business category of the viewing user's selection from the user's circles of social connections, which effectively allows the viewing user to automatically discover favorite businesses and services within the location of his interest in one business category, based on favorite business and services in another business category, whether through his or her own favorite records or the favorite records of his or her social circles;

2. The method according to claim 1, wherein the business category comprises of different “Business Groups” by users' choice. The businesses and services under various “Business Groups” can be offered by registered companies, and can also be offered and owned by private individuals who are marketing, exchanging or selling his or her products and services to other users in the circles.

3. The method according to claim 1, wherein the content of the user favorite records of any business and service comprises a business name, a service item, a title of the record, a descriptive message, a photo image of the item, a time stamp of the record, a location identification, a category used to indicate the reason the business and service is the favorite of the user which further consists of various distinct service characteristics, business classifications, favorite attributes and personal criteria either pre-defined by the computer system, or selected and added by the user. In addition to those items listed above, the content can further comprise a voice record, a video clip, and a link to its web site or other social networking sites of the business and related service.

4. The method according to claim 1, wherein the service characteristics, business classifications, favorite attributes, and personal criteria by the computer system and the users comprise different choices in different business categories. For each business category, the computer system defines on one side a general list of such items for users to choose from in the mobile application, and also provides on the other side a capability for users to create and add new items to the computer system, for their own interest, which can be made available to the public of all users by the computer system if such items become popular among many users.

5. The method according to claim 1, wherein the uploaded user records to the server database is stored with the indication of the user favorite characteristics, classifications, attributes, and criteria either determined by the user at the time of generating and uploading these records, or by the computer system automatically based on the user's past preferences and the preference profiles of the business and services.

6. The method according to claim 1, wherein the users comprise of at least two major groups. One group consists of general consumers who are the end users of the mobile application for their own interest and convenience to explore the businesses and related services of their favors, while the other group consists of the business owners who register with the computer system for the businesses and services they own, describe and market in the computer system their businesses and services, classify their businesses and services into categories, define their businesses' general preferences, specific focus, and detailed specialties, generate and upload to the server database the commercial records for their businesses' service items, using the same format of user records which is defined according to claim 3. The business owners can login into their respective business accounts, edit and modify any information and photos contained in the records, such as service item price, service item photo, special coupon, specific seasonal or occasional a notice to their customers through Internet means. Those edits, modifications, promotions, coupons, new or updated service items, sales and marketing presentations, can be made open to users in real time if the private settings of the business profile permit such transparency. If the owners of their businesses and services register also with the computer system as general end users to explore other businesses and services of their own favors and conveniences, those accounts registered by them are treated by the computer system as normal individual user accounts which are not different from those of other users as end consumers.

7. The method according to claim 1, wherein the user records inside server database comprise of two different domains, one data domain for consumers and another data domain for businesses. These two domains of data further comprise user favorite records and business service items, respectively, while each record is further categorized by various service characteristics, business classifications, favorite attributes and personal criteria under different business groups, different businesses, different services, and different times and locations, which are represented by the specific database table designs and structures.

8. The method according to claim 1, wherein the user favorite records are searched, sorted, compared and ranked such that a common link between two users is established internally inside the server database, if a shared interest in any one of characteristics, classifications, attributes, and criteria is found between the two users for the same business and service. The ranking of the matching between two users is determined and weighted by both the number of internal links established between them and by the number of the shared interest in each link. Each user has a ranking list of matching users based on the internal social links inside the computer database system. The internal social links among all the users form the framework of an internal mobile social network that is only visible to the computer systems, not to the linked users. This forms the basis of user matching by common favorite to certain businesses and services, through the automatic and dynamic correlation of the uploaded information and pre-defined profiles and settings.

9. The method according to claim 8, wherein the computer system allows the user to initiate social connection requests to other users with whom the user has established internal links inside the computer system. Pending on the privacy settings of the receiving user and his or her response to the user's connection request, the computer system puts the internal links into different status to indicate the acceptance, rejection or on-hold of the connection request by the receiving user. Once accepted, the internal links between the two users become the external links and visible to both users so that the two users become connected in the content correlated and favorite focused social network. Each user can view the other user's other favorites under the same business category.

10. The method according to claim 8, wherein the computer system utilizes the users from the ranking matching list for the viewing user, and searches for the favorite businesses and services by these users in the server database based on their uploaded records, within the desired proximity of the viewing user, and makes a list of ranking recommendations to the viewing user for favorite businesses and services under the same business category as indicated in the established internal links. This forms the basis for self discovery of favorite businesses and services under the same business category group.

11. The method according to claim 9, wherein the computer system utilizes the users from the external social links of the viewing user under one business category as indicated in the established internal links, and searches for the favorite businesses and services by these users in the server database based on their uploaded records, within the desired proximity of the viewing user, and makes a list of ranking recommendations to the viewing user for favorite businesses and services, under a different business category as selected by the viewing user. In this case, the viewing user may not need to have any known preferences and records in this new business category. The ranking recommendation list may mainly come from the known favorite businesses and services of these ranking matching users in the viewing user's internal and external social links in the other business category where the viewing user has some shared common interests with his or her circles of links.

12. The method according to claim 6, wherein the business and service records in the server database uploaded by the business owners are open and visible to all general purpose end users. Each consumer can search for the businesses, the service items, the related records, the business classifications, the business preferences, the detailed specialities, in order to find out whether the relevant business and service is of his or her own interest, matching some of his or her preferences and favorite service attributes, or personal criteria. Each business owner can update any time the business information and the service records, which is then made visible to all end users by the computer system.

13. The method according to claim 6, wherein the business and service records uploaded by the business owners in the server database comprise the information about the price of the service items, which are made visible by the computer system, either to all users or to the users paying for the service items. The option is set by the business owner in his or her business profile and security settings and utilized by the computer system.

14. The method according to claim 6, wherein the business and service records uploaded by the business owners in the server database are connected directly and automatically by the computer system to the online service capabilities related to the relevant businesses and services. Those capabilities comprise of one or some combinations of the following items, namely, the online ordering capability which allows the consumers to order directly online from the computer system for the business service items and to pay for them directly, the online reservation capability which allows the consumers to make reservations to the business service items online, the online coupon capability which allows the consumers to view and utilize the available coupons online directly for the business service items, and also other online service capabilities. All of these online service capabilities are the integral part of the content correlated and service focused dynamic social mobile network in the current computer system, enabling businesses and services to have full control of their online offerings in real time, and consumers to have full visibility and capability to review and utilize those services offered by businesses.

15. The method according to claim 11, further comprising the steps of:
Obtaining one business group category A with the viewing user's input and selection;
Under this business group category A, obtaining the viewing user's profile, preference setting, user's favorite table, user's favorite records, user's internal and external social connections, and calculating the user's ranking list of matching users, as in claim 8;
Obtaining another business group category B based on the user's input and selection, obtaining a new list of nearby businesses and services under this business group B;
Under the business group category B, comparing the viewing user's profile and preference setting, user's favorite table and user's favorite records, discovering some of the nearby businesses and services that match with the viewing user's favorite setting or uploaded history, and assigning weighting functions to the favorite businesses and services based on the number of the matches and frequency of the matched occurrences in the uploaded user favorite records, as in claim 10;
Under the business group category B, going through the list of the ranking matching users of the viewing user through his or her internal and external social connections, discovering the favorite nearby businesses and services by those ranking matching users, and assigning weighting functions to the favorite businesses and services based on the number of the matches and frequency of the matched occurrences in their uploaded user favorite records, as well as the number of the established links between the viewing user and the other user in the viewing user's ranking matching list.
Comparing and ranking the list of nearby businesses and services obtained from the viewing user's own preferences and uploaded records, with the list obtained from the preferences and uploaded records of other users who are in the ranking matching list of the viewing user;
Displaying the combined ranking list of nearby favorite businesses and services under the business group category B as the ranking recommendation list to the viewing user based on the viewing user's initial preferred selection under the business group category A. This enables the viewing user to discover favorite businesses and services under one business group category B, based on the known favorite businesses and services by those users in the viewing user's ranking matching list, who share some internal and external social connections in the current computer system with the viewing user, due to their shared interests in some favorite businesses and services under another business group A, which are discovered through the automatic correlation of the contents uploaded to the server database by the viewing user and other users.

16. The method according to claim 9, wherein the external links that connect two users together comprise only the relevant information about the businesses and services, the favorite characteristics, the business classifications, the favorite attributes, the personal criteria, the timestamp, the locations, and the uploaded contents about the relevant businesses and services by the two users if permitted by their respective owners to be open to each other, or to all users in the same shared communities. No personal private and sensitive information, and no other information the owner deems to be important and needs to be protected, are shared or disclosed to each other in such external social network. The social network is built on top of the shared common interest in certain businesses and services among those users who may not know, or need not know, each other in real life for any particular reasons. It is not built to share private and personal sensitive information.

17. The method according to claim 15, wherein the favorite businesses and services of each user discovered through personal preferences or preferences of the other matching users under the same business category or different categories, are organized and categorized in the server database by “Personal Groups” and “Business Groups”, and further by service characteristics and favorite attributes.
